(19) United States
(12) Patent Application Publication
(10) Pub. No.: US 2005/0081795 A1
(43) Pub. Date: Apr. 21, 2005

(54) Therapeutic bird perch

(76) Inventors: Selbourne S. Witter, Keyport, NJ (US); Marcia Y. Witter, Bronx, NY (US); Selbourne R. Witter, Keyport, NJ (US)

Correspondence Address: LITMAN LAW OFFICES, LTD., P.O. BOX 15035 CRYSTAL CITY STATION, ARLINGTON, VA, 22215, US

(21) Appl. No.: 10/685,574

(22) Filed: Oct. 16, 2003

(51) Int. Cl. A01K 31/12

(52) U.S. Cl. 119/468

(57) ABSTRACT

The therapeutic bird perch is a plastic or wood perch having two surface textures, a grooved surface and an abrasive surface. The grooved surface is formed by etching a series of parallel grooves into the surface of the perch. The abrasive surface coats the grooved surface on a portion of the perch only, and is made of resin and sand. The abrasive surface comprises at least two layers: an inner layer of resin and an outer layer of sand laminated to the perch by the resin. The perch can be used alone as a single perch, or in multiples to form rungs of a therapeutic bird ladder. The ladder rungs have different diameters to exercise the feet.

### BACKGROUND OF THE INVENTION

1. Field of the Invention

The present invention relates to bird perches, more particularly to a therapeutic bird perch that trims and conditions a bird's toenails and beak as it sits on the perch. The perch may be furnished in different sizes and incorporated as rungs into a therapeutic bird ladder.

2. Description of the Related Art

Birds, whether kept as pets or held in captivity, survive best in their natural environment or settings that replicate their natural environment. The reason for this is that many of the health benefits obtained by birds are attributed to the environment they inhabit. For example, by perching on a branch of a tree the natural coarseness of the tree bark conditions the bird's feet and trims it's toenails. Tree bark also provides traction to keep the bird perched on the tree without worrying about slipping off the branch. Furthermore, birds that live in the wild remain healthy by exercising their muscles and joints as they climb tree limbs of varying widths.

Since birds are popular pets, many perches have been developed to provide birds with a place to perch, as well as to exercise and help trim and condition their toenails and/or beaks.

U.S. Pat. No. 2,241,259, issued to Hanson on May 6, 1941, describes a perch for trimming a bird's toenails in which the top half of the perch is round and the lower half is V-shaped. The V-shaped portion of the perch is provided with strips of abrasive material, such as sandpaper or emery paper, and is in direct contact with the bird's toenails. The half-round portion is smooth and supports the rest of the foot. U.S. Pat. No. 2,570,663, issued to Guarino on Oct. 9, 1951, describes a perch having an abrasive underside to trim the nails and abrasive strips on the sides of the perch to trim the beak of a bird. The topside of the perch is supports the bird's foot and is non-abrasive. The abrasive underside is either molded to the perch or, in the alternative, is provided by a removable piece attachable to the perch.

British Patent Number 2,338,882, published on Jan. 1, 2000, describes a wood perch having an abrasive underside for trimming the claws of the bird. The abrasive material is preferably a wet and dry paper, or abrasive particles that are adhered to the perch. U.S. Pat. No. 2,076,734, issued to Leindorf on Apr. 13, 1937, describes a perch attachment made of resilient paper that is covered with sand. The attachment slips onto and firmly grips a perch of any size and shape.

U.S. Pat. No. 6,332,431, issued to Brown on Dec. 25, 2001, describes a manually operated trimming perch that prunes the nails of a bird to a predetermined length. The perch has a removable sheet of sandpaper rolled around the core and a perforated sleeve that is movably disposed on the sheet of sandpaper to cut the nails to a preset length. U.S. Pat. No. 5,588,397, issued to Johnakin III on Dec. 31, 1996, describes a perch and disk combination. The perch and disk are made of a solid, abrasive material, such as concrete or resin with gritty material, i.e. sand, embedded within. The perch trims the nails of the bird and the disk trims the bird's beak.

Perches have also been developed that simulate a tree branch or have a wood-like texture. U.S. Pat. No. 5,018,480, issued to Goldman et al. on May 28, 1991, describes a simulated tree branch that can be used as a bird perch. The simulated tree branch is made of plastic, and can be made to have tree-like characteristics, such as twists, knots, bark texture, lumps, holes, buds and leaf scars, tapered ends, broken ends etc. U.S. Pat. No. 5,381,758, issued to Simon on Jan. 17, 1995, describes a parrot tower having a plurality of plastic perches incorporating a wood-like texture, and that are arranged for climbing.

Other perches have been designed as exercise apparatus for birds. U.S. Pat. No. 4,627,384, issued to Courteau on Dec. 9, 1986, describes an exercise apparatus having wooden perch members placed at varying angles and having varying diameters to exercise the feet of a bird. The wooden perches also provide a place to trim the beak and nails of the bird. British Patent Number 2,140,267, published on Nov. 28, 1984, describes a birdcage accessory that is disposed above the cage. The accessory comprises a platform that supports a vertical pole that is used to retain plastic perch members for climbing.

Various ornamental designs for bird perches and ladders are shown or described in U.S. Design Pat. No. 353,693, issued to Lawson on Dec. 20, 1994 (design for a perch); U.S. Design Patent Number 391,690, issued to Edlebeck et al. on Mar. 3, 1998 (design for a perch swing); U.S. Design Patent Number 391,691, issued to Edlebeck et al. on Mar. 3, 1998 (design for a perch ladder); and U.S. Design Pat. No. 420,472, issued to Dellasandro et al. on Feb. 8, 2000 (design for a perch).

Still other perches have been described in U.S. Pat. No. 266,555, issued to Thorpe on Oct. 24, 1882 (spring secured perch prevents insects and vermin from reaching the perch); U.S. Pat. No. 5,487,360, issued to Yau on Jan. 30, 1996 (locating joint of a perching rod that can be fastened securely and quickly to a birdcage); U.S. Pat. No. 5,511,512, issued to Pintavalli et al. on Apr. 30, 1996 (perch and pole assembly, the pole extending from the floor to the ceiling of a room and supporting a perch that is enclosed in a cage); and U.S. Pat. No. 6,484,665, issued to Brown et al. on Nov. 26, 2002 (serrated perch on a bird feeder).

None of the above inventions and patents, taken either singly or in combination, is seen to describe the instant invention as claimed. Thus a therapeutic bird perch solving the aforementioned problems is desired.

### SUMMARY OF THE INVENTION

The therapeutic bird perch is a plastic or wooden perch having two surface textures, including a grooved surface and an abrasive surface. The grooved surface is formed by etching a series of parallel grooves into the surface of the perch. A portion of the grooved surface is then coated with an abrasive material, formed by laminating a non-toxic, silica-free sand to the perch with a polyester casting resin. The two different surfaces of the perch both condition and trim the bird's toenails, and stimulate nerve endings and blood circulation in the feet. The perch can be used alone as a single perch, or in multiples to form rungs of a therapeutic bird ladder. The ladder rungs have different diameters to exercise the feet, and also help to trim the toenails and beak.

Accordingly, it is a principal object of the invention to provide a therapeutic bird perch having two different textured surfaces, including a grooved surface and an abrasive surface.

It is another object of the invention to provide a bird perch which simulates a natural tree branch or limb by providing the perch with a grooved texture for therapeutically improving the health of a bird's feet.

It is a further object of the invention to provide a therapeutic bird perch having both grooved and abrasive surfaces to stimulate the nerve endings and blood circulation in the feet, and to trim and condition a bird's toenails and beak.

Still another object of the invention is to provide a perch that can be used to form rungs of a ladder, wherein each rung is of a different diameter.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a therapeutic bird perch and therapeutic bird ladder according to the present invention.

FIG. 2 is an exploded view of the therapeutic bird perch according to the present invention.

FIG. 3 is front view of an alternative embodiment of the therapeutic bird perch of the present invention in which the abrasive surface forms a spiral design.

FIG. 4 is front view of another alternative embodiment of the therapeutic bird perch of the present invention in which the abrasive surface covers one end of the perch.

FIG. 5 is front view of a third alternative embodiment of the therapeutic bird perch of the present invention in which the perch is twisted.

FIG. 6 is a perspective view of a bird ladder incorporating therapeutic bird perches having different diameters as rungs of the ladder according to the present invention.

Similar reference characters denote corresponding features consistently throughout the attached drawings.

### DETAILED DESCRIPTION OF THE PREFERRED EMBODIMENTS

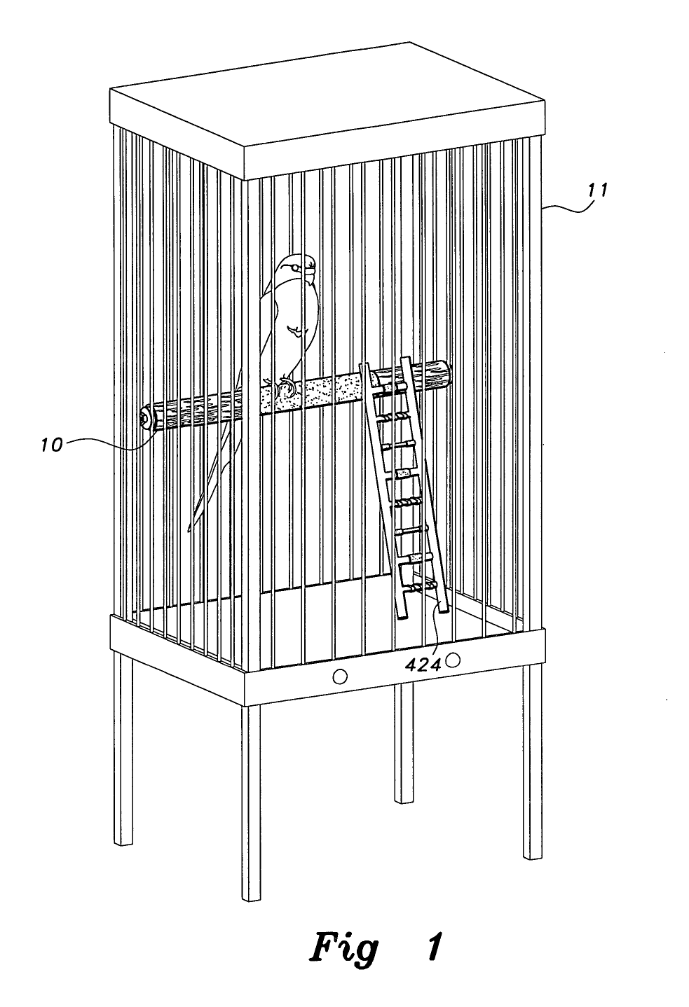

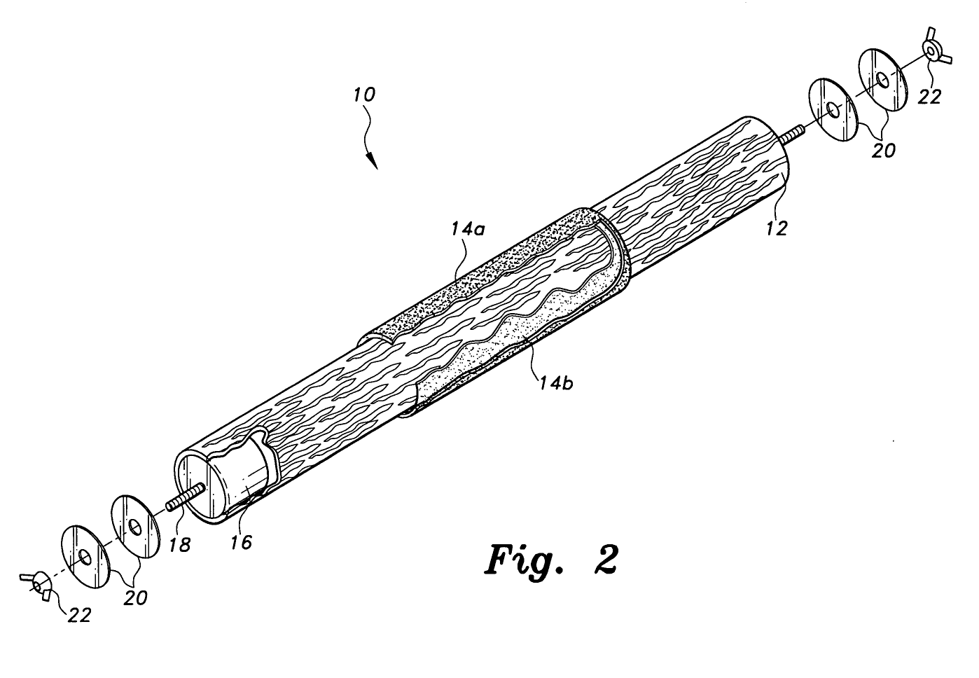

The present invention is a therapeutic bird perch 10, as shown in FIG. 1. The bird perch 10 can be modified to form rungs 428 of a therapeutic bird ladder 424, also shown in FIG. 1. As shown in the drawing, the perch 10 is positioned in a birdcage 11 at a comfortable elevation for use by a bird. FIG. 2 shows an exploded view of the perch 10. In the preferred embodiment, the perch 10 is formed by a cylindrical shaft 12 having two surfaces, including a grooved surface 12a and an abrasive surface 14a, 14b. Although the shaft 12 is shown in FIG. 2 as a straight, round, linear shaft, the shaft 12 can alternatively be formed with right angled edges, i.e., from square tubing, or can be contorted, bent, or twisted.

The perch 10 is preferably made of polyvinyl chloride (PVC) pipes or tubes, or from solid wood stock, but other materials may also be used. Grooves 12a are etched into the shaft surface 12 using a table saw. The blade of the table saw is adjusted to shallow depths to create the grooved 12a texture. Two types of designs can be etched into the shaft 12, a spiral design and a straight design. The spiral design is formed by rotating the PVC in a circular motion while moving the shaft 12 axially as the blade cuts the grooves. The straight design is made by moving the PVC shaft 12 axially in a back and forth motion while turning the PVC shaft slightly as the shaft 12 is drawn across the blade. The grooves 12a are preferably arranged in a series of parallel rows, however, other designs can be etched into the surface as well.

The abrasive surface 14a, 14b is disposed above the grooved surface 12a and encircles a portion of the perimeter of the shaft 12 to be in contact with both the toenails and base of the feet. The abrasive surface 14a, 14b comprises one or more base coats of resin 14b coated with a resin-sand 14a layer. The resin 14b is a tacky material that is applied to the surface 12 of the perch 10 in a number of coats. Normally the number of coats applied to the surface of the shaft 12 depends on the size of the bird the perch 10 is made for. If the perch 10 is used for a small bird, then preferably two coats are applied. If the perch is made for a bigger bird, then three or more coats are applied. The resin 14b used to coat the shaft 12 is a gel coat resin, preferably a highly resilient isophthalic polyester casting resin, such as R0213 polyester casting resin made by HK Research Corporation of Hickory, N.C. The resin is typically used for making countertops and other flat stocks, and produces a tough, chemically resistant coating with excellent light transmission properties.

The final coat includes a layer of sand 14a poured over a tacky layer of the resin, which is deposited over the base layer(s) 14b to form the abrasive surface 14a, 14b. The sand is preferably non-toxic, silica-free, and can come in a variety of colors. A suitable sand for the abrasive layer is a colored sand made for the arts and crafts industry by Sandtastik, Inc. of Niagara Falls, N.Y. In FIG. 2, the abrasive surface 14a, 14b is formed as a cylindrical band disposed around the center portion of the perch 10. The abrasive surface 14a, 14b helps to prevent the formation of calluses on the bird's feet, a common malady associated with conventional, smooth surfaced bird perches. The grooved surface 12a and the abrasive surface 14a, 14b help the bird to trim its toenails, and provides reflexology benefits to the bird by stimulating the nerve endings and blood circulation in the base of the bird's feet. As an added benefit, the two surfaces provide traction under the bird's feet to help it remain on the perch 10 without sliding off.

Still referring to FIG. 2, the perch 10 may be formed as a hollow shaft 12, optionally having end caps 16 inserted at its ends. The end caps 16 fully enclose the ends of shaft 12 and anchor a retaining member such as a hanger bolt 18. The hanger bolt 18 is threaded into the center of the end caps 16, a portion of the hanger bolt 18 extending from the end cap 16. The perch 10 is secured to an appropriate support by placing washers 20 and a fastening nut, preferably a wing nut 22, onto the exposed end of the hanger bolt.

To fix the perch 10 in a birdcage 11, wing nut 22 and one washer 20 is removed from the hanger 18 leaving the second washer 20 on the hanger bolt 18 adjacent the end cap 16. The perch 10 is then placed inside the cage 11, horizontally, at a desired elevation, the hanger bolts 18 exiting through the bars of the cage. The second washer 20 and wing nut 22 are then placed on the end of the hanger bolt 18. The walls of the cage 11 become sandwiched between two washers 20.

Instead of a hollow shaft, the perch 10 can be constructed from a solid cylindrical shaft, e.g., from wood stock. When the perch 10 is made from a solid shaft 12, the end caps 16 may be dispended with, and the hanger bolts 18 may be screwed directly into the ends of the perch 10 of course, hangar bolts are not essential to the present invention, and other conventional hardware or fixtures may be used to support the ends of the perch 10.

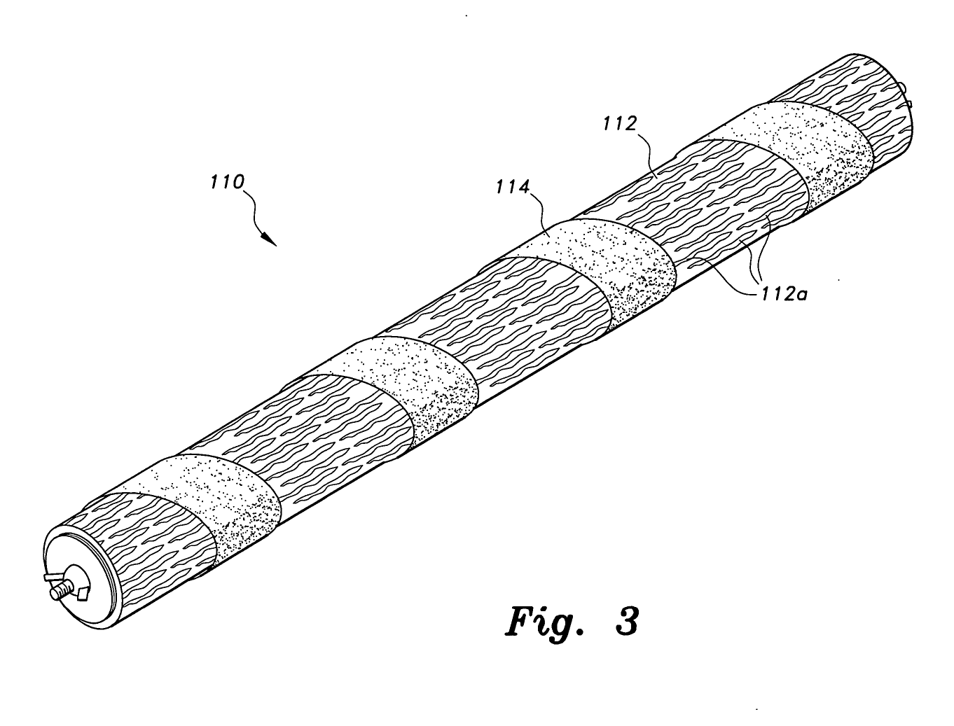

The perch 10 can be made in several different configurations possessing the same basic features of the perch 10 of FIG. 2. For example, FIG. 3 shows perch 110 with the abrasive surface 114 forming a spiral design. The spiral design is created by first applying tape to the grooved surface 112a of the shaft 112 in a spiral fashion. Resin is then coated over the shaft 112, and then sand is poured over the resin while it is still tacky, followed by allowing the sand to adhere to the resin. Once the sand sets, the tape is removed from the shaft 112 to expose the abrasive surface 114 having a spiral design.

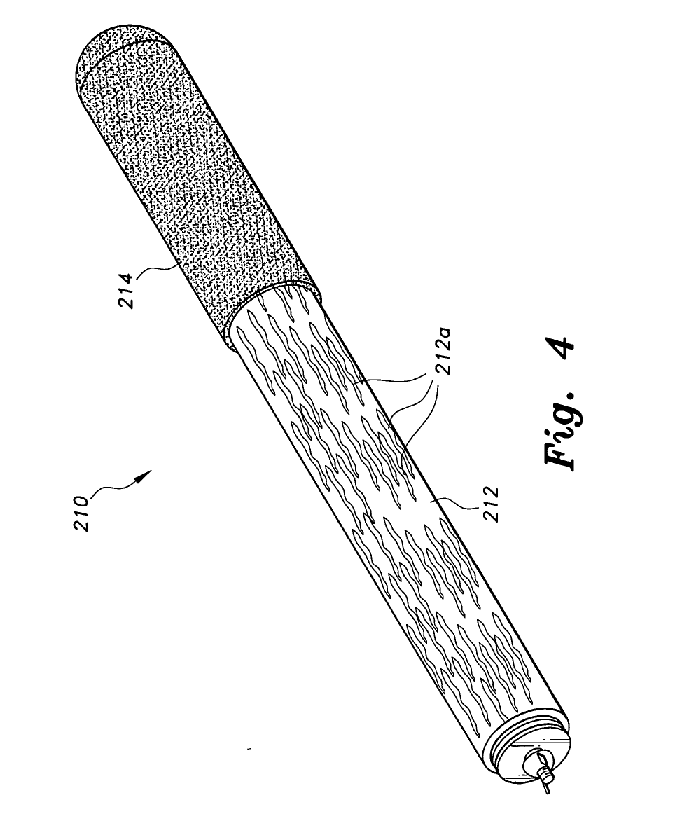

In another configuration, the abrasive surface 214 is disposed at one end of the shaft 212, as seen in FIG. 4. As in the preferred embodiment 10, the perch 210 is etched with a series of grooves 212a. Here, only one end has the securing members, hanger 18, washers 20 and wing nut 22 combination to fix the perch to the walls of a cage 11, so that the perch 210 is supported in cantilever fashion. The free end of the perch 210 is covered with the abrasive material 214. The perch is susceptible of numerous configurations created by altering the design of the abrasive surface on the perch, which can take a number of other forms and is not limited to the configurations illustrated by the drawings.

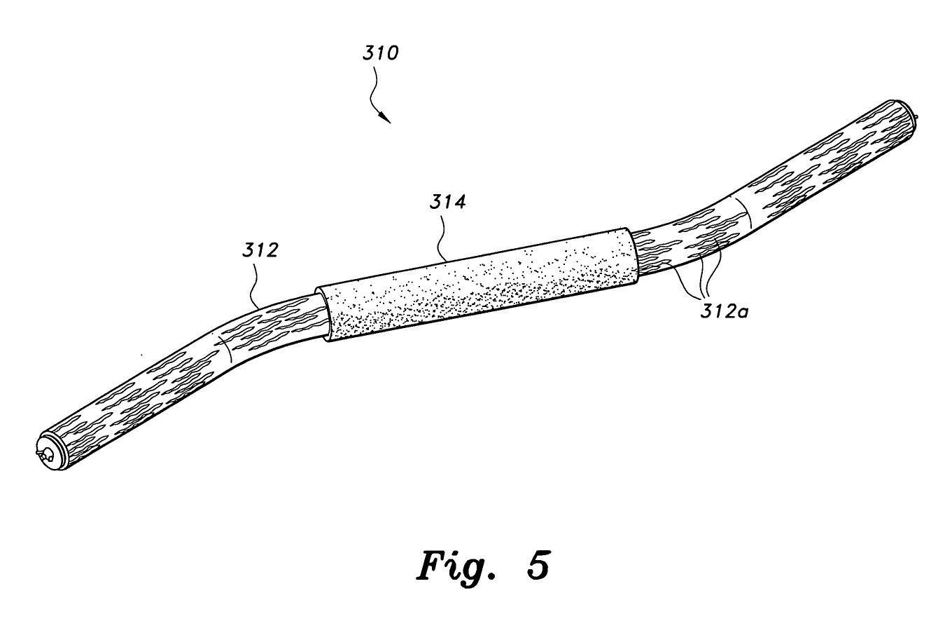

FIG. 5 shows configuration of the perch 310 in which the perch 310 is contorted with bends or twists formed in the PVC shaft 312. The surface of the shaft 312 is grooved 312a and the abrasive material 314 is located in a central area on the shaft 312. However, the abrasive surface 314 can be located on the entire surface of the shaft 312, at one end of the shaft 312, at both ends of the shaft 312 or in a spiral design on the shaft 312.

In all of the above embodiments, the perches 110, 210, 310 can be fastened to the cage 11 in the same manner as shown above. The width and length of the perch 10, 110, 210, 310 can vary, depending on the type and size of bird the perch is made for. For example, the diameter can be ½ inch, ¾ inch, 1 inch, 1¼ inch, 1½ inch, 1¾ inch, 2¼ inches, 2½ inches and 3 inches, while the length can range from as short as twelve inches up to and over twenty-four inches. These dimensions are illustrative and are not meant to be limiting.

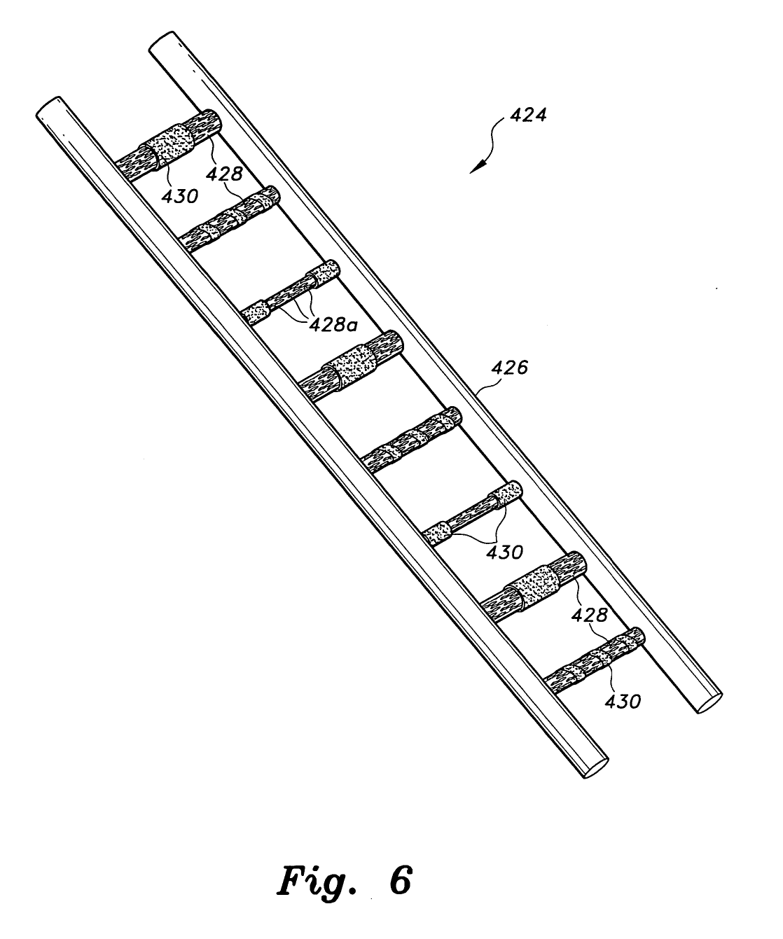

In a further variation, the perch 10 can be altered to serve as rungs of a therapeutic bird ladder 424, as shown in FIG. 6. The ladder 424 provides a place for the bird to climb, and at the same time a place to condition and trim both it's toenails and beak. The ladder 424 is made of two parallel poles 426 and a number of rungs 428 that are parallel to each other and lie at a set distance from each other. The poles 426 and rungs 428 are preferably cylindrical, but they can be rectangular or square in cross section. Each rung 428 has a grooved surface 428a and an abrasive surface 430. The abrasive surface 430 may be a cylindrical shell in the center or at the ends of the rungs, formed in a spiral extending across the rung, etc.

The poles 426 of the ladder 424 can be either solid or hollow. If the poles 426 are hollow, the user may decide to keep the ends open or, if desired, cover the ends with end caps to seal the openings of the poles 426. If the end caps are used to make the ladder 424, the top-end caps can be domed for aesthetic reasons, while the bottom end caps are made flat in order to provide greater surface contact with the floor of the cage, or other supporting surface.

The poles 426 of the ladder 424 preferably have a length of thirty-six inches and a diameter of 1¼ inch. The length of each rung 428 is at least six inches long, while the diameters range from ½ inch, ¾ inch to 1 inch. Again, these dimensions are only meant to be illustrative, other dimensions can also be used. The ladder rungs 428 each have different diameters, which forces the bird to exercise its feet by opening and closing it's toes around each rung 428 as it climbs the ladder 424. The abrasive surface 430 found on the rungs 428 helps to maintain and trim the beak and toenails of the bird as it climbs the ladder 424.

It is to be understood that the present invention is not limited to the embodiments described above, but encompasses any and all embodiments within the scope of the following claims.

1. A therapeutic bird perch, comprising:
a cylindrical shaft of unitary construction having two opposing ends, the shaft having a perching surface circumferentially extending between the opposing ends and a plurality of longitudinal grooves etched into the perching surface, the longitudinal grooves being disposed in an irregular pattern of parallel rows circumferentially encircling the entire perching surface to simulate a natural tree branch; and
an abrasive coating disposed about a portion of the perching surface, wherein said abrasive coating comprises a resin and sand;
whereby the perch therapeutically simultaneously stimulates blood circulation and nerve endings in a bird's feet when the bird stands on the perch.

2. (canceled).

3. (canceled).

4. The therapeutic bird perch of claim 1, wherein the abrasive coating encircles the perching surface.

5. (canceled).

6. The therapeutic bird perch of claim 5, wherein said resin coats the perching surface and said sand coats the resin.

7. The therapeutic bird perch of claim 1, wherein said shaft is hollow.

8. The therapeutic bird perch according to claim 7, further comprising an end cap disposed over at least one of the two opposing ends of the shaft.

9. The therapeutic bird perch according to claim 1, further comprising a hangar bolt extending from at least one of the opposing ends of said shaft for mounting the shaft to a support.

10. The therapeutic bird perch according to claim 1, wherein said shaft is made from polyvinyl chloride tubing.

11. The therapeutic bird perch according to claim 1, wherein said abrasive coating is formed as a cylindrical shell disposed around said shaft.

12. The therapeutic bird perch according to claim 1, wherein said abrasive coating is disposed about a center portion of said shaft.

13. The therapeutic bird perch according to claim 1, wherein said abrasive coating is spirally wound around said shaft in a spiral between the opposing ends.

14. The therapeutic bird perch according to claim 1, wherein said abrasive coating comprises:
at least one base coat of a polyester casting resin; and
non-toxic, silica free sand laminated onto said base coat.

15. A therapeutic bird ladder, comprising:
a pair of parallel poles;
a plurality of the therapeutic bird perches according to claim 1 forming rungs disposed between the parallel poles.

16. The therapeutic bird ladder according to claim 15, wherein at least two of said perches have different diameters from one another, whereby the bird exercises muscles of the feet to grasp the different diameter perches when climbing the ladder.

17. A therapeutic bird ladder, comprising:
a pair of parallel poles;
a plurality of rungs disposed between the parallel poles, each of the rungs including:
a cylindrical shaft of unitary construction having two opposing ends, the shaft having a perching surface circumferentially extending between the opposing ends and a plurality of longitudinal grooves etched into the perching surface, the longitudinal grooves being disposed in an irregular pattern of parallel rows circumferentially encircling the entire perching surface to simulate a natural tree branch; and
an abrasive coating disposed about a portion of the perching surface, wherein the abrasive coating comprises a resin and sand.

18. The therapeutic bird ladder according to claim 17, wherein at least two of said rungs have a different diameter different diameters from one another.

19. The therapeutic bird ladder according to claim 17, wherein said abrasive coating comprises:
at least one base coat of a polyester casting resin; and
non-toxic, silica free sand laminated onto said base coat.
